(19) United States
(12) Patent Application Publication
(10) Pub. No.: US 2020/0160414 A1
(43) Pub. Date: May 21, 2020

(54) PHOTOGRAPHING DEVICE AND SELLING METHOD

(71) Applicant: Chang Yub HAN, Namyangju-si (KR)

(72) Inventors: Chang Yub HAN, Namyangju-si (KR); Jun Min HAN, Namyangju-si (KR)

(21) Appl. No.: 16/480,289

(22) PCT Filed: Jan. 24, 2018
(86) PCT No.: PCT/KR2018/001041

§ 371 Date: Jul. 23, 2019

(30) Foreign Application Priority Data
Jan. 24, 2017 (KR) 10-2017-0011233
Sep. 7, 2017 (KR) 10-2017-0114742
Sep. 22, 2017 (KR) 10-2017-0122388

(51) Int. Cl. G06Q 30/06; G06Q 30/02; G06F 3/0484; G06F 3/0481

(52) U.S. Cl. CPC G06Q 30/0601; G06Q 30/02; H04N 5/232; G06F 3/04815; G06F 3/04842

(57) ABSTRACT

Disclosed are a photographing apparatus and a selling method using the same. A selling method using a photographing apparatus of the present invention includes photographing an object to be photographed by a photographing apparatus and then generating an object modeling, registering sales information of the object modeling through a website, and applying a sales support when the sales information is registered.

### CROSS-REFERENCE TO RELATED APPLICATIONS

This application is based on and claims the benefit of priorities to Korean Patent Application Nos. 10-2017-0011233, 10-2017-0114742 and 10-2017-0122388 filed on Jan. 24, 2017, Sep. 7, 2017 and Sep. 22, 2017, in the Korean Intellectual Property Office, the disclosure of which is incorporated herein by reference.

### BACKGROUND OF THE INVENTION

### Field of the Invention

The present invention relates to a photographing apparatus and a selling method using the same and more particularly, to a photographing apparatus and a selling method using the same capable of selling an object photographed by a photographing apparatus with marketing activities of a sales supporter and receiving a support of the sales supporter.

### Description of the Related Art

In general, a picture refers to a technology of photographing an image of an object of a camera which photographs a person or an object on a film or a dry plate using lenses or an image shown on a photographic paper, which has been used for permanent storage and display and appreciation of a moment or, scenery, and various objects to be memorized.

In order to take a picture, first, a camera consisting of components having various functions and an operation lever, a film inserted to the camera to record an image of the object, a lighting means (a flash for the camera) for indicating a clear outline of the object when photographing, and the like (hereinafter, referred to as a photographing means) are required. Even if the photographing means is provided, a specialized skill for appropriately operating the photographing means if necessary is required.

A camera which is mainly generally used may be simply and easily photographed by anyone, but in order to take pictures (precious metals, advertising pictures, etc.) to be used for commercial purposes, separate special equipment and specialized skills are required in addition to the aforementioned photographing means.

In order to take commercial pictures, it is required to photograph an object to be photographed at various angles, and as a result, since there are disadvantages in that a lot of times and efforts are required and efficiency and commercial applications are deteriorated by the current photographing apparatus, improvements thereof are required.

Meanwhile, when the object to be photographed is sold through a website after the object to be photographed is photographed by the aforementioned photographing means, previously, for most cases, a manufacturer of the object to be photographed sells the object to be photographed by directly operating a website or by investing separate costs in a sale website.

In this case, it a third party is induced for the sale of the object to be photographed, it is so helpful in marketing and sales, and as a result, improvements therefor are also required.

The above-described technical configuration is a background technique for assisting the understanding of the present invention, and does not mean a conventional technology widely known in the art to which the present invention belongs.

### SUMMARY OF THE INVENTION

Therefore, an object of the present invention is to provide a photographing apparatus and a selling method using the same capable of inducing a third party to sales of an object to be photographed to apply the induced third party to the marketing and improve the sales and photographing easily the object to be photographed.

Further, another object of the present invention is to provide a selling method capable of selling an object to be photographed by a rotary photographing apparatus with marketing activities of a sales supporter, receiving the support of the sales supporter, and immediately paying an object to be photographed on advertising pages where the object to be photographed is advertised.

According to an aspect of the present invention, there is provided a selling method including: generating an object modeling of an object photographed by a photographing apparatus through a user terminal accessing a server; registering sales information of the object modeling in a website through the user terminal accessing the server; and applying a sales support through the user terminal accessing the server when the sales information is registered.

When the object which is applied with the sales support is advertised and sold through SNS or blogs, and a home page of the sales supporter through the user terminal accessing the server, sales support money may be paid to the sales supporter through a user terminal of the sales supporter accessing the server.

The sales support money may be an amount of money input through the user terminal of the sales supporter accessing the server.

The object modeling may be converted and registered into any one of virtual reality (VR), augmented reality (AR), and 3D modeling.

An advertisement may be inserted to the object modeling converted into the VR.

According to another aspect of the present invention, there is provided a photographing apparatus including: a main body; a rotary plate rotatably coupled to the main body; a rotary plate driver provided in the main body to rotate the rotary plate; and a support plate detachably coupled to the rotary plate and supporting the object to be photographed on an upper surface thereof.

The main body may include a base body; a central post provided at a center of the base body and connected to the rotary plate; a plurality of support posts provided at an edge of the base body; an accommodating box provided in the plurality of support posts; and a spherical body accommodated in the accommodating box and coming into a cloud contact with the rotary plate.

According to yet another aspect of the present invention, there is provided a selling method including: generating an object modeling of an object to be photographed by a rotary photographing apparatus through a user terminal accessing a server; registering sales information of the object modeling in a website through the user terminal accessing the server; advertising the object to be photographed by SNS or blogs, and a home page of a sales supporter through the user terminal accessing the server; and applying a sales support through the user terminal accessing the server when the sales information is registered, wherein a payment of a purchaser is immediately made through the server on an advertisement page where the object to be photographed is advertised.

A product to be advertised may be selected by the purchaser through the user terminal.

A separate website link may be provided to the sales supporter through the server.

When the object to be photographed which is applied with the sales support is advertised and sold through SNS or blogs, and a home page of the sales supporter through the user terminal accessing the server, sales support money may be paid to the sales supporter through a user terminal of the sales supporter accessing the server, and the sales support money may be an amount of money input through the user terminal of the sales supporter accessing the server.

According to still another aspect of the present invention, there is provided a selling method in an image including: registering sales information of a sales product which is an object to be photographed by a photographing apparatus in an image including a moving picture through a user terminal accessing a server or a specific program; generating a marker on the sales product using the user terminal accessing the server or the specific program or an image matching technique; and distributing an image generated with the marker and a webpage, wherein sales information for the sales product is shown when the purchaser clicks the marker.

When the marker is clicked, the sales information in the image may be immediately displayed and the sales product is immediately purchased.

When there is a plurality of sales products in the image, the marker may be provided for each sales product.

The marker may be hidden or shown by an operation event selected from on/off, mouse over, and pause according to an interface operation.

At least one of a list of characters, a list of brands, and a list for each sales product appearing at a current time of the image may be shown in a separate layout outside the image.

The separate layout may be hidden or shown.

The sales information may be three-dimensionally shown.

At least one of a manager, an image producer, a publisher, a character, a product brand company, and an image distributor may get a payment at a predetermined ratio when the sales product is sold.

When the sales product is purchased in offline, purchase information may be stored in a storage device and then transmitted in a batch during an online connection.

According to the embodiments of the present invention, a third party may be guided to sales of the object to be photographed to be used for marketing and improve the sales, the object to be photographed may be conveniently photographed by a photographing apparatus rotating the object to be photographed, and the support plate of the photographing apparatus is detachably coupled to the rotary plate to variously use a bracket to which the object to be photographed is fixed.

Further, it is possible to sell an object to be photographed by a rotary photographing apparatus with marketing activities of a sales supporter, receive the support of the sales supporter, and immediately pay an object to be photographed on advertising pages where the object to be photographed is advertised, thereby improving convenience.

Furthermore, when the purchaser clicks the marker generated on the sales product, the sales information on the sales product is displayed and then the purchaser may immediately purchase the product to prevent damage from similar products, and a customer may immediately purchase the product without the need to search for the corresponding product to increase a sales rate.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram schematically illustrating a selling method using a photographing apparatus according to an embodiment of the present invention;

FIG. 2 is a diagram schematically illustrating a server and participants used in the selling method of FIG. 1;

FIG. 3 is a perspective view illustrating a photographing apparatus which is applied to the selling method illustrated in FIG. 1;

FIG. 4 is an exploded perspective view of FIG. 3;

FIG. 5 is a bottom perspective view of a rotary plate illustrated in FIG. 4;

FIG. 6 is a diagram illustrating a selection screen for sales registration after photographing is completed, as a use state diagram of the present embodiment;

FIG. 7 is a diagram schematically illustrating a screen after the sales registration is selected in FIG. 6;

FIG. 8 is a diagram schematically illustrating a screen of selecting whether to transmit an object modeling link with a text as a next screen of FIG. 7;

FIG. 9 is a screen of inputting a mobile phone number to send a text as a next screen of FIG. 8;

FIG. 10 is a diagram schematically illustrating a selling method using a rotary photographing apparatus according to an embodiment of the present invention;

FIG. 11 is a diagram schematically illustrating an edition screen of an image transmitted to a company's servers in the present embodiment;

FIG. 12 is a diagram schematically illustrating a screen of inputting sales support information in the present embodiment;

FIG. 13 is a diagram schematically illustrating supporting a separate link to a sales supporter in the present embodiment;

FIG. 14 is a diagram schematically illustrating a screen of promoting an object to be photographed by a sales supporter using a separate link provided to the sales supporter in the present embodiment;

FIG. 15 is a diagram schematically illustrating a screen of immediately releasing a payment of a purchaser on an advertising page where the object to be photographed is advertised in the present embodiment;

FIG. 16 is a diagram schematically illustrating a screen of selecting whether to transmit an object modeling link with a text in the present invention;

FIG. 17 is a screen of inputting a mobile phone number to send a text as a next screen of FIG. 16;

FIG. 18 is a perspective view illustrating a rotary photographing apparatus which is applied to the selling method of the present embodiment;

FIG. 19 is an exploded perspective view of FIG. 18;

FIG. 20 is a bottom perspective view of a rotary plate illustrated in FIG. 19;

FIG. 21 is a diagram schematically illustrating a selling method in an image according to an embodiment of the present invention;

FIG. 22 is a diagram illustrating main parts of the present embodiment;

FIG. 23 is a diagram illustrating a purchase screen shown to immediately purchase a sales product by a purchaser when clicking a marker illustrated in FIG. 22;

FIG. 24 is a perspective view illustrating a photographing apparatus which is applied to the selling method of the present embodiment;

FIG. 25 is an exploded perspective view of FIG. 24; and

FIG. 26 is a bottom perspective view of a rotary plate illustrated in FIG. 25.

### DETAILED DESCRIPTION OF THE PREFERRED EMBODIMENT

In order to fully understand the present invention, operational advantages of the present invention and objects achieved by implementing the present invention, the prevent invention will be described with reference to the accompanying drawings which illustrate preferred exemplary embodiments of the present invention and the contents illustrated in the accompanying drawings.

Hereinafter, preferred exemplary embodiments of the present invention will be described in detail with reference to the accompanying drawings. Like reference numerals illustrated in the respective drawings designate like members.

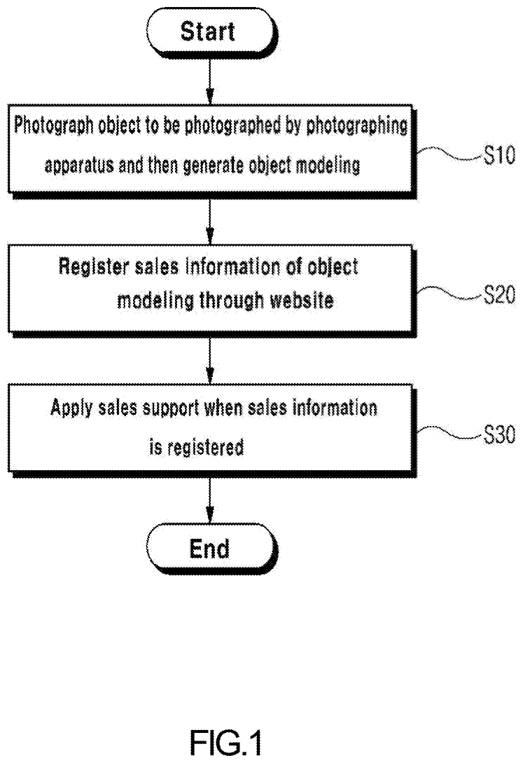

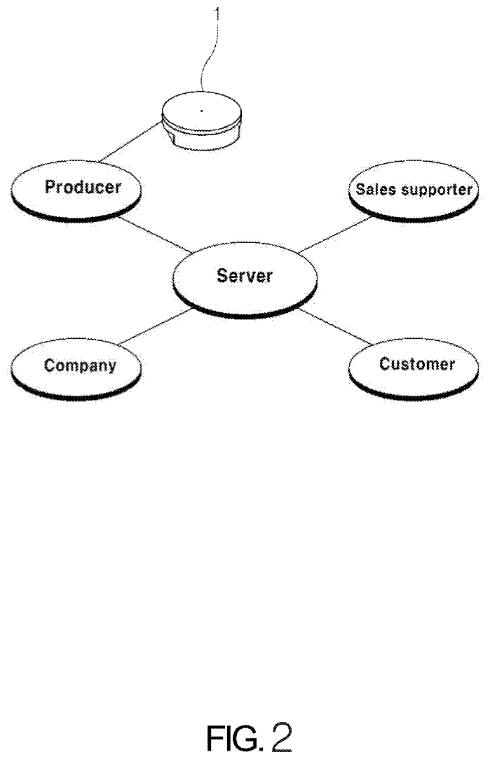

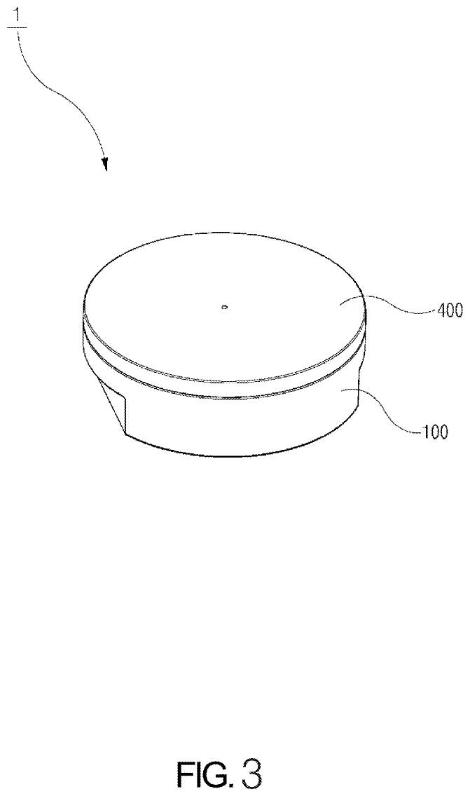

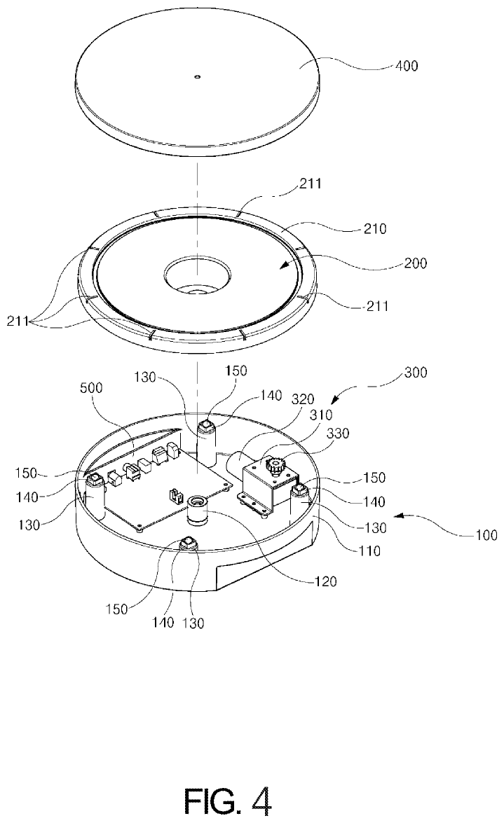

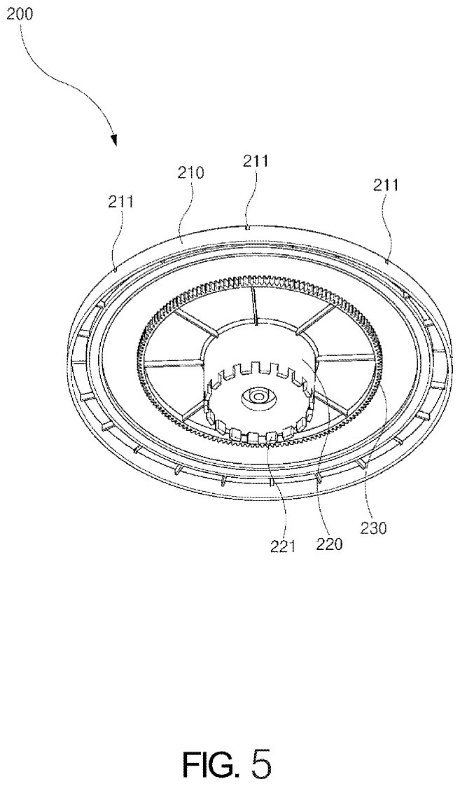

FIG. 1 is a diagram schematically illustrating a selling method using a photographing apparatus according to an embodiment of the present invention, FIG. 2 is a diagram schematically illustrating a server and participants used in the selling method of FIG. 1, FIG. 3 is a perspective view illustrating a photographing apparatus which is applied to the selling method illustrated in FIG. 1, FIG. 4 is an exploded perspective view of FIG. 3, and FIG. 5 is a bottom perspective view of a rotary plate illustrated in FIG. 4.

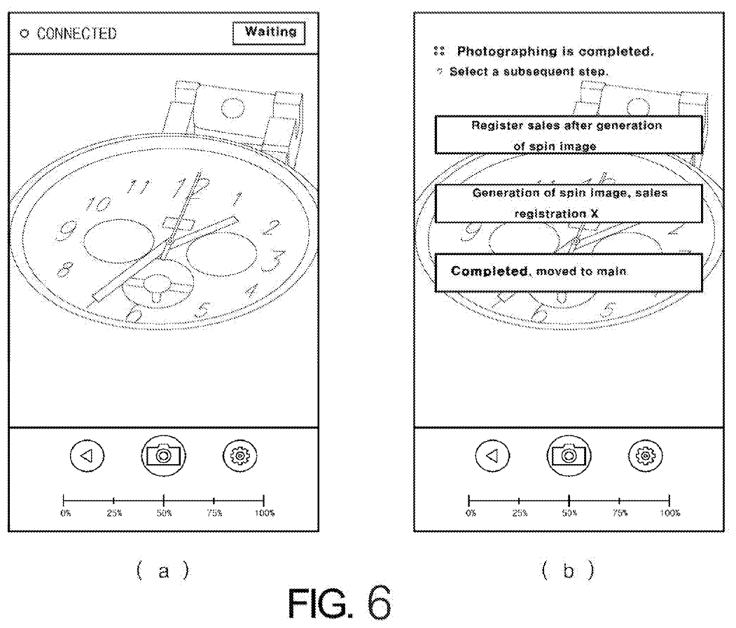

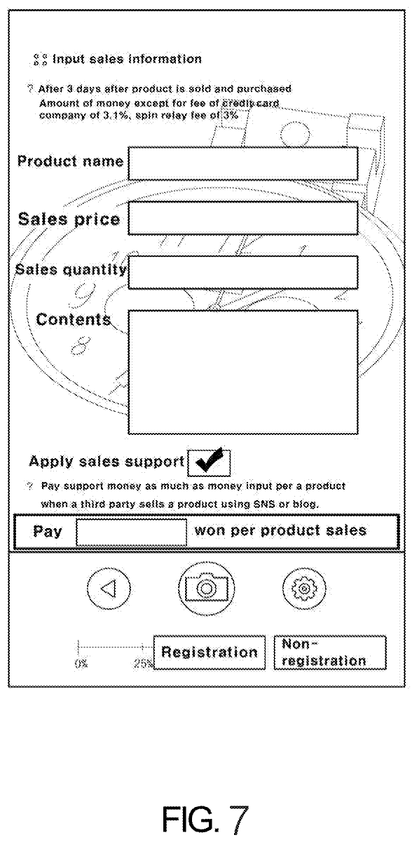

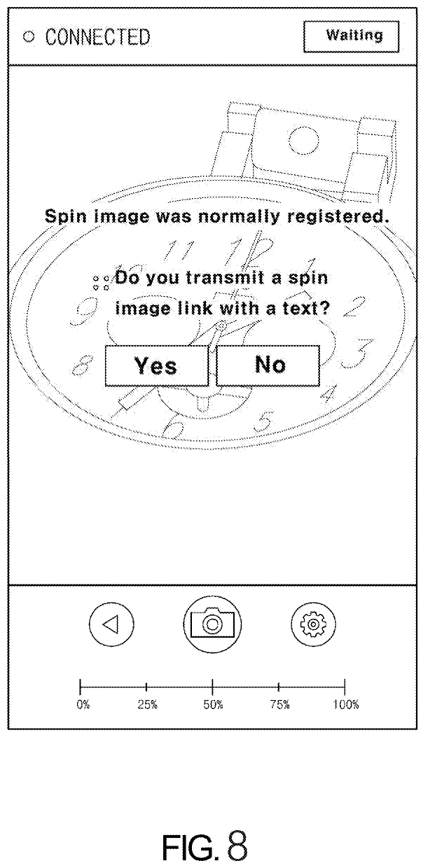

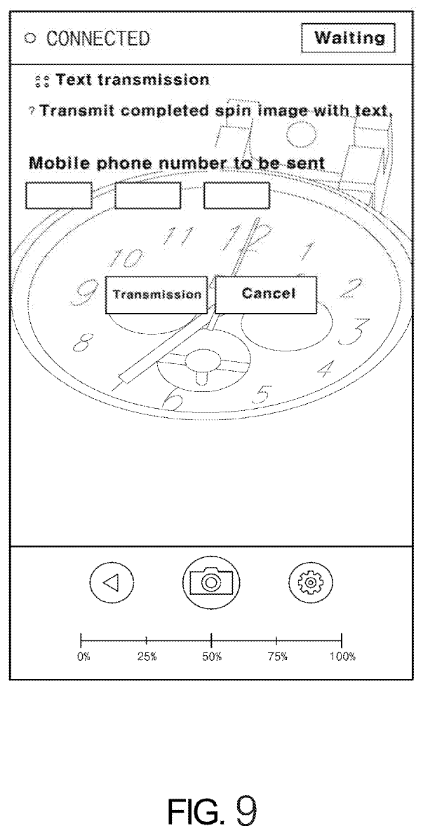

FIG. 6 is a diagram illustrating a selection screen for sales registration after photographing is completed, as a use state diagram of the present embodiment, FIG. 7 is a diagram schematically illustrating a screen after the sales registration is selected in FIG. 6, FIG. 8 is a diagram schematically illustrating a screen of selecting whether to transmit an object modeling link with a text as a next screen of FIG. 7, and FIG. 9 is a screen of inputting a mobile phone number to send a text as a next screen of FIG. 8.

As illustrated in these drawings, a selling method using a photographing apparatus according to an embodiment includes photographing an object to be photographed by a photographing apparatus 1 and then generating an object modeling (S10), registering sales information of the object modeling through a website (S20), and applying a sales support when the sales information is registered (S30).

In the photographing of the object to be photographed, the photographing apparatus 1 illustrated in FIGS. 3 to 5 may be used. In the present invention, the object to be photographed may rotate at 360° using the photographing apparatus 1 and a bracket on which the object to be photographed is mounted may be variously selected.

As illustrated in FIG. 4, the photographing apparatus 1 employed in the present embodiment includes a main body 100, a rotary plate 200 rotatably coupled to the main body 100, a rotary plate driver 300 provided in the main body 100 to rotate the rotary plate 200, and a support plate 400 detachably coupled to the rotary plate 200 and supporting the object to be photographed on an upper surface thereof.

As illustrated in FIG. 4, the main body 100 includes a base body 110, a central post 120 provided at a center of the base body 110, a plurality of support posts 130 provided at an edge of the base body 110, an accommodating box 140 provided in the plurality of support posts 130, and a spherical body 150 accommodated in the accommodating box 140 and coming into a cloud contact with an inner ceiling portion of a rotary body 210.

As illustrated in FIG. 4, the base body 110 of the main body 100 may have a hollow circular shape on a plan view.

The central post 120 of the main body 100 is provided at the center of the base body 110, wherein the rotary plate 200 may be rotatably coupled.

As illustrated in FIG. 4, four support posts 130 of the main body 100 may be provided to be spaced apart from each other at an inner bottom edge of the base body 110.

As illustrated in FIG. 4, the accommodating box 140 of the main body 100 is provided at an upper end of the support post 130 and serves to hold the spherical body 150 so as not to be separated to the outside.

As illustrated in FIG. 4, the spherical body 150 of the main body 100 is accommodated in the accommodating box 140 and comes into a cloud contact with the inner ceiling portion of the rotary body 210 to easily rotate the rotary body 210.

In the present embodiment, the spherical body 150 may have a circular shape.

The rotary plate 200 may be connected to the rotary plate driver 300 provided in the base body 100 to be rotatably provided in the main body 100 at 360°.

In the present embodiment, as illustrated in FIG. 5, the rotary plate 200 includes a rotary body 210, a rotary support post 220 provided at the inner ceiling portion of the rotary body 210 and connected to the central post 120, and a driven gear 230 provided at the rotary body 210 and gear-engaging with a drive gear 330 of the rotary plate driver 300.

As illustrated in FIGS. 4 and 5, in the rotary body 210 of the rotary plate 200, a plurality of coupling grooves 211 are provided to be spaced apart from each other, and coupling protrusions provided on a lower surface of the support plate 400 may be inserted and coupled to the plurality of coupling grooves 211.

As illustrated in FIG. 5, the rotary support post 220 of the rotary plate 200 is provided at the center of the rotary body 210 and connected to the central post 120 of the main body 100 to rotatably support the rotary body 210.

In the present embodiment, as illustrated in FIG. 5, at a lower side of the rotary support post 220, a recessed groove and a protruding rod disposed on the recessed groove may be provided.

Further, in the present embodiment, as illustrated in FIG. 5, at a lower end of the rotary support post 220, a saw-toothed concave-convex portion 221 may be provided.

As illustrated in FIG. 5, the driven gear 230 of the rotary plate 200 is continuously provided between the rotary support post 220 and an outmost edge of the rotary body 210 and may gear-engage with the drive gear 330 of the rotary plate driver 300. As a result, when the drive gear 330 rotates, the rotary plate 200 may rotate at 360° by gear engagement between the drive gear 330 and the driven gear 230.

As illustrated in FIG. 4, the rotary plate driver 300 is disposed in the base body 110 and connected with the rotary plate 200 to rotate the rotary plate 200 at 360° and in forward and backward directions.

Meanwhile, in the present embodiment, after the supporting plate 400 is separated, the bracket on the object to be photographed is mounted may be coupled and used to the rotary body 210. At this time, the bracket may be fitted and coupled to the groove provided at the center of the rotary body 210.

In the present embodiment, as illustrated in FIG. 4, the rotary plate driver 300 includes a driver bracket 310 coupled to a bottom of the base body 110, a drive motor 320 coupled to the driver bracket 310 and electrically operating, and the drive gear 330 connected with a gear provided at the drive motor 320 to be rotated and gear-engaging with the driven gear 230.

The drive gear 330 of the rotary plate driver 300 may be rotatably supported to a bearing provided in the bracket and although not illustrated, a lower gear gear-engaging with the gear of the drive motor 320 may be provided at the lower side of the drive gear 330.

The support plate 400 is detachably coupled to an upper side of the rotary plate 200 illustrated in FIG. 4 to support the object to be photographed and may rotate at 360° like the rotary plate 200.

In the present embodiment, a coupling protrusion is provided on the support plate 400, and the coupling protrusion may be fitted and coupled to the coupling groove 211 provided on the upper surface of the rotary body 210 illustrated in FIG. 4. In addition, the support plate 400 may be detachably coupled to the rotary body 210 by a known coupling means, for example, a screw coupling and the like.

Further, in the present embodiment, a hole or a groove is provided at the center of the support plate 400 and a bracket may be fitted and coupled to the hole or the groove.

In the present embodiment, the object to be photographed, such as a full-body mannequin, upper and lower half-body mannequins, hats, watches, and accessories, maybe fixed to the bracket.

As illustrated in FIG. 4, a controller 500 is provided in the base body 110 and in the present embodiment, the controller 500 may wirelessly receive a remote signal from a remote controller or a smart phone to drive the drive motor 320.

In addition, in the present embodiment, the photographing apparatus 1 may further include a photographing unit such as a DSLR or a smart phone in addition to the main body 100, the rotary plate 200, the rotary plate driver 300, the support plate 400, and the controller 500 described above. Further, in the present embodiment, the photographing unit may include a 3D scanner. That is, after the object to be photographed is scanned by the 3D scanner, the scanned object is converted into a 3D modeling to be uploaded on a website.

In the present embodiment, an image photographed by the photographing unit is generated as an object modeling and the generated object modeling may be registered in the website through the server. At this time, the object modeling may be converted into virtual reality to be registered on the website and an advertisement may be inserted to the object modeling converted into the VR. Further, in the present embodiment, the object modeling may also be converted into augmented reality (AR).

In the present embodiment, the converting of the object modeling into the VR or the inserting of the advertisement to the object modeling converted into the VR may be applied with a known technical means as it is. In addition, the modeling of the object modeling to a 3D object may be applied with a technique disclosed in Korean Patent Registration No. 10-1562658 filed and registered by the present applicant as it is.

When the object modeling is generated and then registered on the website, a producer may select whether to or not register the sales as illustrated in FIG. 6(b).

In order to register the sales, a spin image illustrated in FIG. 6(b) is generated and then a sales registration menu is clicked to be moved to the menu illustrated in FIG. 7.

The producer may input a product name, a sales price, a quantity sold, contents, a sales assist request, and sales support money and then select a registration menu or a non-registration menu.

When the producer selects the registration menu, the screen is moved to the menu illustrated in FIG. 8, and when the producer selects the non-registration menu, the screen may go on to a photographing page.

When the producer continuously selects the menu illustrated in FIG. 8, the screen may go on to a text transmission menu illustrated in FIG. 9.

Meanwhile, when the producer selects the sales registration menu illustrated in FIG. 6(b), the screen may go on to the menu illustrated in FIG. 8.

In addition, in the present embodiment, the sales may be made when actual sales are made from a company's site (safe transaction scheme) and when the actual sales are made from a producer's site (direct transaction scheme). In the present embodiment, the company includes an Internet sales site except for the producer's site.

First, when the actual sales are made from the company's site, the producer applies a sales support when registering the product and inputs product information and sales information of the producer to the company when the product is registered.

At this time, the producer inputs the sales support money illustrated in FIG. 7 and the input sales support money is paid to the sales supporter when the product is sold by the support of the sales supporter.

The sales supporter checks the products supported in sales from the company's site and selects a product which the sales supporter wants to promote to advertise the product through SNS or blogs, and a home page of the sales supporter. When customers facing the object to be photographed through the advertisement purchase the product, the purchasing is made from a shopping mall of the actually registered company or producer.

When the object to be photographed is actually sold and the sales profit is generated, the company pays the sales support money except for a sales fee to the sales supporter leading to the actual purchase and pays the remaining money to the producer.

Finally, when the actual sales are made from the producer's site, the producer applies a sales support when registering the product and inputs product information of the producer to the company and inputs sales information to the producer's site when the product is registered.

The sales supporter checks the object to be photographed to be supported in sales from the company's site and selects a product which the sales supporter wants to promote to advertise the product through SNS or blogs, and a home page of the sales supporter. When the customers facing the object to be photographed through the advertisement purchase the product, the purchasing is made from a shopping mall of the producer.

When the product is actually sold and the sales profit is generated, the producer pays the sales support money to the sales supporter. When the direct sales are made from the producer's site without a help of the sales supporter, the producer gets all profits.

In the present embodiment, an advertisement selected from the company may be inserted to a 3D picture produced by the producer, and this advertisement profit may be distributed with the producer. In addition, the producer may select a desired advertisement.

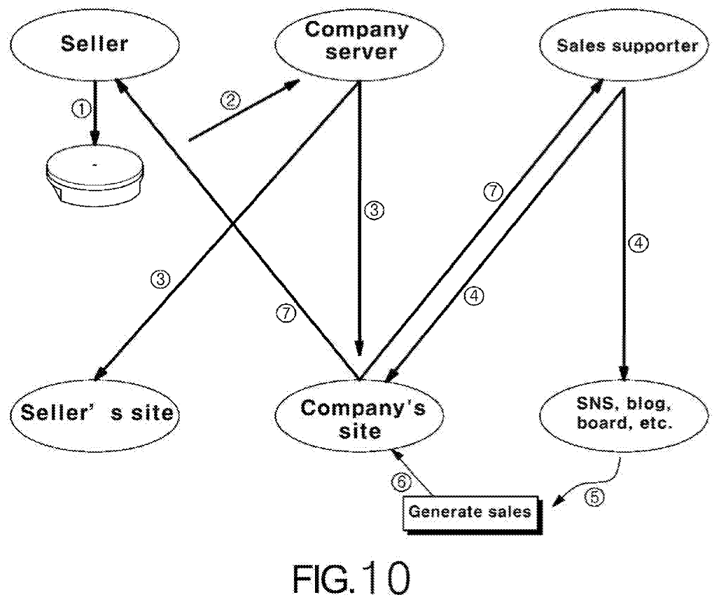

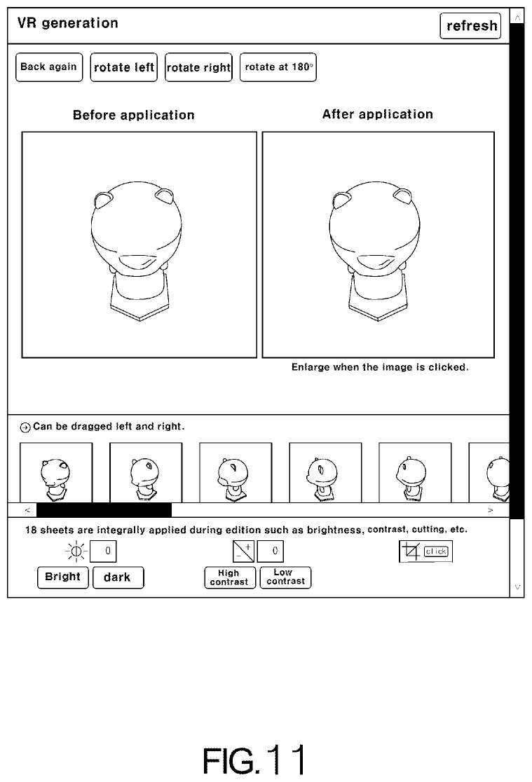

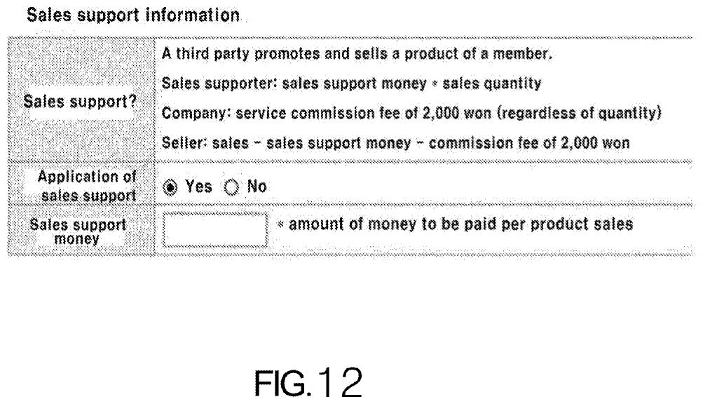

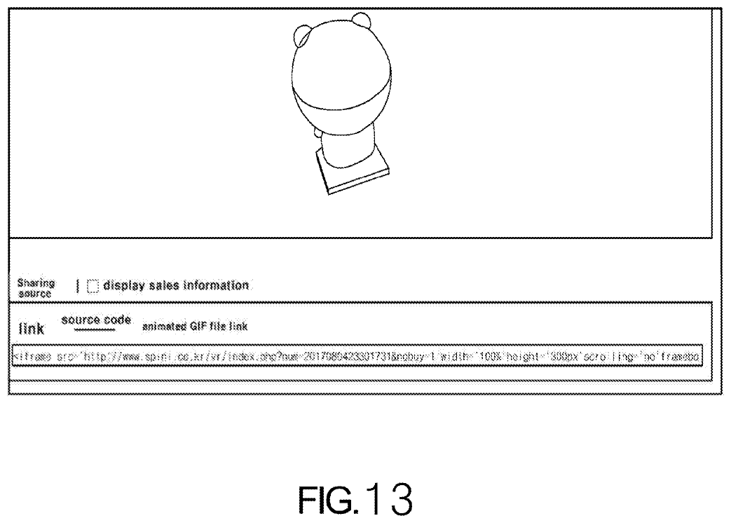

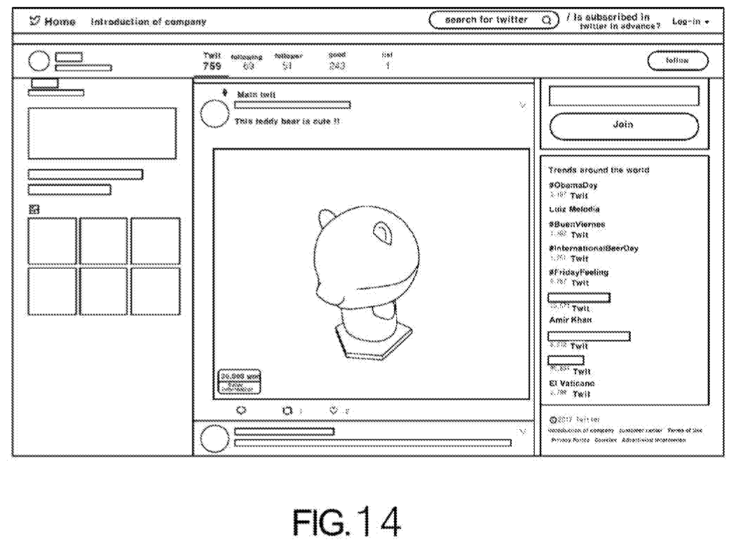

FIG. 10 is a diagram schematically illustrating a selling method using a rotary photographing apparatus according to an embodiment of the present invention, FIG. 11 is a diagram schematically illustrating an edition screen of an image transmitted to a company's servers in the present embodiment, FIG. 12 is a diagram schematically illustrating a screen of inputting sales support information in the present embodiment, FIG. 13 is a diagram schematically illustrating supporting a separate link to a sales supporter in the present embodiment, and FIG. 14 is a diagram schematically illustrating a screen of promoting an object to be photographed by a sales supporter using a separate link provided to the sales supporter in the present embodiment.

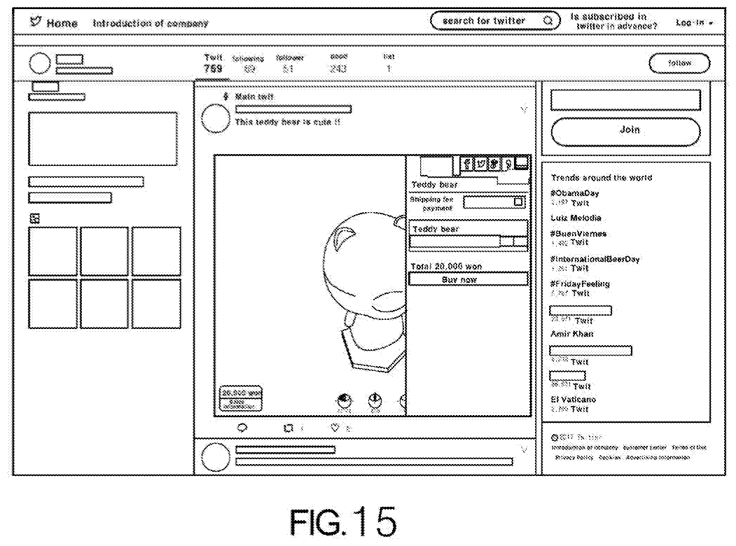

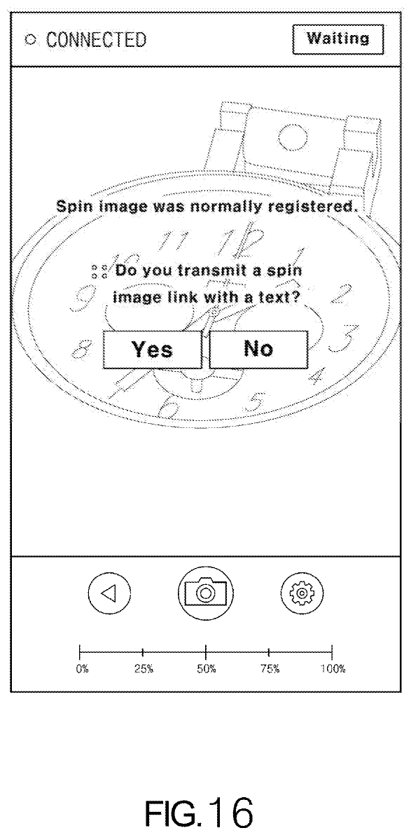

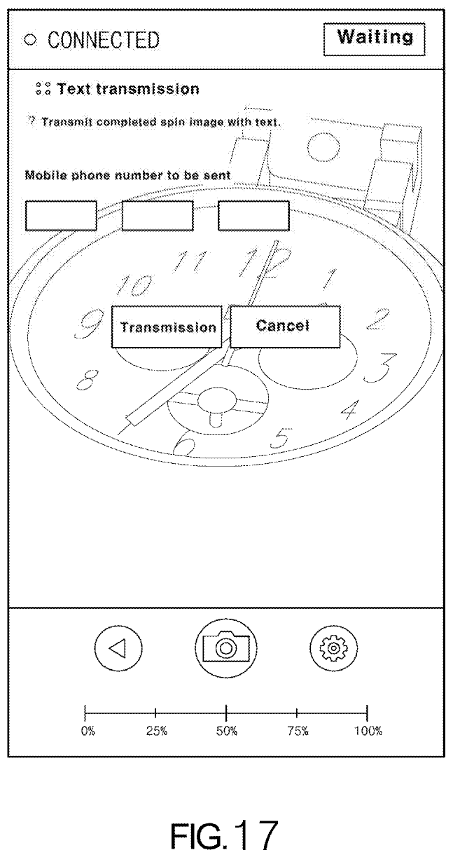

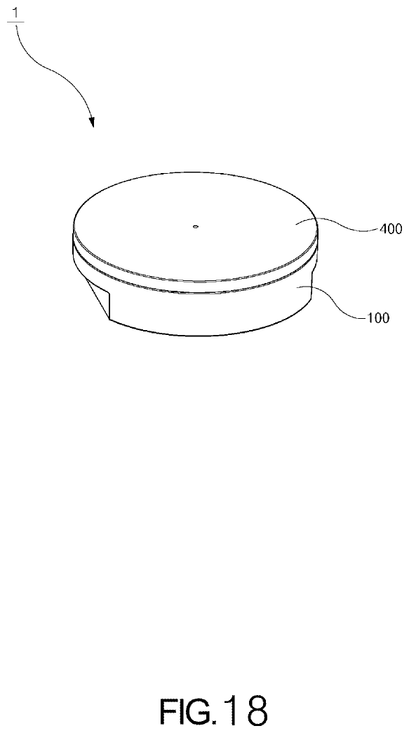

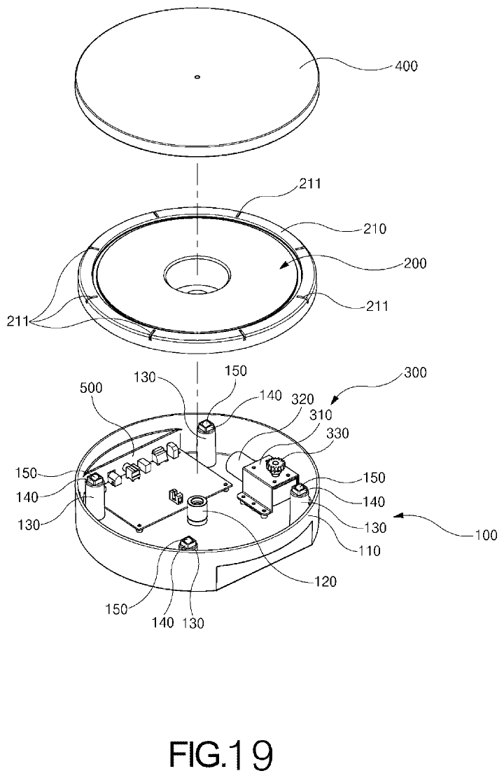

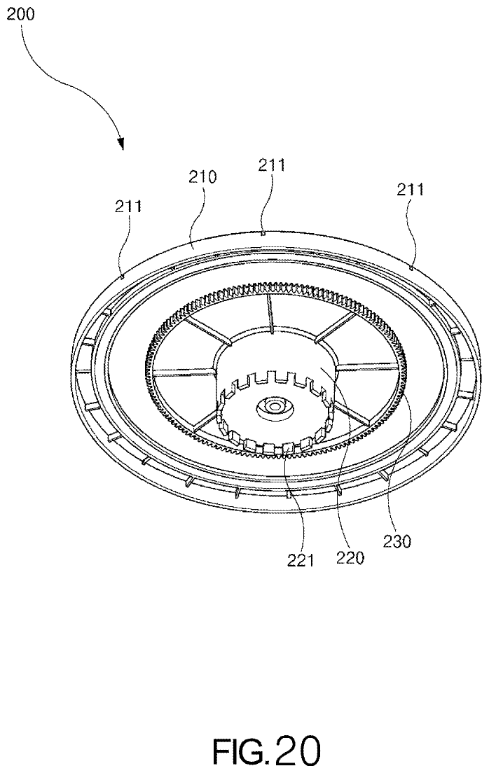

FIG. 15 is a diagram schematically illustrating a screen of immediately releasing a payment of a purchaser on an advertising page where the object to be photographed is advertised in the present embodiment, FIG. 16 is a diagram schematically illustrating a screen of selecting whether to transmit an object modeling link with a text in the present invention, FIG. 17 is a screen of inputting a mobile phone number to send a text as a next screen of FIG. 16, FIG. 18 is a perspective view illustrating a rotary photographing apparatus which is applied to the selling method of the present embodiment, FIG. 19 is an exploded perspective view of FIG. 18, and FIG. 20 is a bottom perspective view of a rotary plate illustrated in FIG. 19.

As illustrated in these drawings, a selling method using a rotary photographing apparatus according to the present embodiment includes generating an object modeling of an object to be photographed by a rotary photographing apparatus 1 through a user terminal accessed to a server, registering sales information of the object modeling on a website through the user terminal accessed to the server, advertising the object to be photographed through SNS or blogs, and a home page of a sales supporter through the user terminal accessed to the server, and applying a sales supporter through the user terminal accessed to the server when the sales information is registered.

In the present embodiment, an image photographed by the rotary photographing apparatus 1 is generated as an object modeling and the generated object modeling may be registered in the website through the server.

In the present embodiment, the rotary photographing apparatus 1 may photograph the object to be photographed at various angles and may operate by interworking with a DSLR or a smart phone. The rotary photographing apparatus 1 of the present embodiment may be used by a seller having the object to be photographed or an agent (photographer) of the seller. Further, in the present embodiment, the rotary photographing apparatus 1 may include a DSLR or a smart phone.

In the present embodiment, the modeling of the object modeling to a 3D object may be applied with a technique disclosed in Korean Patent Registration No. 10-1562658 filed and registered by the present applicant as it is. In the present embodiment, rendering is available even in other servers which are previously predetermined in addition to the company's server.

In the present embodiment, the object modeling is converted into virtual reality (VR) to be registered in a website, i.e., a company's site or a seller's site through the company's server, and when the VR is generated, a separate link to be provided to the sales supporter may be generated. In the present embodiment, a technique of generating a separate link may be applied with a known technique as it is.

In the present embodiment, the image photographed by the rotary photographing apparatus 1 may be transmitted to the company's server.

In the present embodiment, the edition of the image may be made in a mobile device or a PC before the image is transmitted and the edition may be made in the company's server after the image is transmitted to the company's server. Further, in the present embodiment, the edition function may also be omitted. In addition, in the present embodiment, the edition function may have functions such as brightness, contrast, crop, and rotation as illustrated in FIG. 11.

In the present embodiment, the advertisement may be inserted to the object modeling converted into the VR. Further, in the present embodiment, the object modeling may also be converted into augmented reality (AR).

In the present embodiment, the converting of the object modeling into the VR or the inserting of the advertisement to the object modeling converted into the VR may be applied with a known technical means as it is.

In the present embodiment, the seller may generate the object modeling and then register the sales in a company's site or a seller's site through the company's server. In the present embodiment, the sales may be simultaneously or selectively registered in the website of the company, the website of the seller, and other open markets, and other sites. In the present embodiment, regardless of before and after the generation of VR, basic information on product sales may be received at a sales registration timing. In the present embodiment, during the sales registration, when a third party promotes and sells the object to be photographed which is a product of the seller, sales support money to be provided may be input.

In the present embodiment, the seller may select cases where the sales are registered or not registered.

In the present embodiment, during the sales registration, the sales support money illustrated in FIG. 12 may be input in addition to the basic information required during the sales, such as a product name, a sales price, a sales quantity, and contents. This sales support money may be provided to an associate member by supporting the sales of the object to be photographed.

In the present embodiment, the seller may generate a spin image as the object modeling converted into the VR and then click a sales registration menu, and input a product name, a sales price, a sales quantity, contents, a sales support request, and sales support money, and then select a registration menu or a non-registration menu.

When the seller selects the registration menu, the screen is moved to the menu illustrated in FIG. 16, and when the seller selects the non-registration menu, the screen may go on to a photographing page.

When the producer continuously selects the menu illustrated in FIG. 16, the screen may go on to a text transmission menu illustrated in FIG. 17. On the contrary, when the producer selects the non-registration menu, the screen may go on to the menu illustrated in FIG. 16.

Meanwhile, in the present embodiment, the sales supporter may promote the product of the seller and select an item to be promoted by the sales supporter from products uploaded by the sellers. In this case, the sales supporter may select the item to be promoted to receive a separate link (see FIG. 13) designated by the sales supporter. This function is possible even in the company's site or a separate seller's site.

In this case, the sales supporter may expose a product using various means such as boards, SNS, blogs, and a home page of the sales supporter using the generated separate link to induce the purchase.

In the present embodiment, when there is a purchaser, the purchaser may immediately make a payment from the corresponding advertisement page illustrated in FIG. 15 without the need to move through the link. In the present embodiment, a payment function in the corresponding VR may be generated. Further, in the present embodiment, the screen maybe moved to a payment page using a QR code and a payment link may be transmitted by a short message service (SMS).

In addition, in the present embodiment, the sales may be made by actual sales made from a company's site (safe transaction scheme) and the actual sales made from a producer's site (direct transaction scheme).

First, when the actual sales are made from the company's site, the seller applies a sales support when registering the product and inputs product information and sales information of the seller to the company when the product is registered.

At this time, the seller inputs the sales support money illustrated in FIG. 12 and the input sales support money is paid to the sales supporter when the product is sold by the support of the sales supporter.

The sales supporter checks the products supported in sales from the company's site and selects a product which the sales supporter wants to promote to advertise the product through SNS or blogs, and a home page of the sales supporter. When customers facing the object to be photographed through the advertisement purchase the product, the purchasing is made from a shopping mall of the actually registered company's site or seller' site.

When the object to be photographed is actually sold and the sales profit is generated, the company pays the sales support money except for a sales fee to the sales supporter leading to the actual purchase and pays the remaining money to the seller.

Finally, when the actual sales are made from the seller's site, the seller applies a sales support when registering the product and inputs product information of the seller to the company's site and inputs sales information to the seller's site when the product is registered.

The sales supporter checks the object to be photographed to be supported in sales from the company's site and selects a product which the sales supporter wants to promote to advertise the product through SNS or blogs, and a home page of the sales supporter. When the customers facing the object to be photographed through the advertisement purchase the product, the purchasing is made from a shopping mall of the seller' site.

When the product is actually sold and the sales profit is generated, the seller pays the sales support money to the sales supporter. When the direct sales are made from the seller's site without a help of the sales supporter, the seller gets all profits.

In the present embodiment, an advertisement selected from the company may be inserted to a 3D picture produced by the seller, and this advertisement profit may be distributed with the seller. In addition, the seller may select the desired advertisement.

In addition, in the present embodiment, after the purchase is made from the site promoted by the sales supporter, the seller may make a payment directly to the sales supporter after the profits are deposited to a seller's account when the sales are completed.

Further, in the present embodiment, the company may receive a fee for the corresponding service.

In the present embodiment, in the photographing of the object to be photographed, a rotary photographing apparatus 1 illustrated in FIGS. 12 to 20 may be used. In the present invention, the object to be photographed may rotate at 360° using the rotary photographing apparatus 1 and a bracket on which the object to be photographed is mounted may be variously selected.

As illustrated in FIG. 19, the rotary photographing apparatus 1 employed in the present embodiment includes a main body 100, a rotary plate 200 rotatably coupled to the main body 100, a rotary plate driver 300 provided in the main body 100 to rotate the rotary plate 200, and a support plate 400 detachably coupled to the rotary plate 200 and supporting the object to be photographed on an upper surface thereof.

As illustrated in FIG. 19, the main body 100 includes a base body 110, a central post 120 provided at a center of the base body 110, a plurality of support posts 130 provided at an edge of the base body 110, an accommodating box 140 provided in the plurality of support posts 130, and a spherical body 150 accommodated in the accommodating box 140 and coming into a cloud contact with an inner ceiling portion of a rotary body 210.

As illustrated in FIG. 19, the base body 110 of the main body 100 may have a hollow circular shape on a plan view.

The central post 120 of the main body 100 is provided at the center of the base body 110, wherein the rotary plate 200 may be rotatably coupled.

As illustrated in FIG. 19, four support posts 130 of the main body 100 may be provided to be spaced apart from each other at an inner bottom edge of the base body 110.

As illustrated in FIG. 19, the accommodating box 140 of the main body 100 is provided at an upper end of the support post 130 and serves to hold the spherical body 150 so as not to be separated to the outside.

As illustrated in FIG. 19, the spherical body 150 of the main body 100 is accommodated in the accommodating box 140 and comes into a cloud contact with the inner ceiling portion of the rotary body 210 to easily rotate the rotary body 210.

In the present embodiment, the spherical body 150 may have a circular shape.

The rotary plate 200 may be connected to the rotary plate driver 300 provided in the base body 100 to be rotatably provided in the main body 100 at 360°.

In the present embodiment, as illustrated in FIG. 20, the rotary plate 200 includes a rotary body 210, a rotary support post 220 provided at the inner ceiling portion of the rotary body 210 and connected to the central post 120, and a driven gear 230 provided at the rotary body 210 and gear-engaging with a drive gear 330 of the rotary plate driver 300.

As illustrated in FIGS. 19 and 20, in the rotary body 210 of the rotary plate 200, a plurality of coupling grooves 211 are provided to be spaced apart from each other, and coupling protrusions provided on a lower surface of the support plate 400 may be inserted and coupled to the plurality of coupling grooves 211.

As illustrated in FIG. 20, the rotary support post 220 of the rotary plate 200 is provided at the center of the rotary body 210 and connected to the central post 120 of the main body 100 to rotatably support the rotary body 210.

In the present embodiment, as illustrated in FIG. 20, at a lower side of the rotary support post 220, a recessed groove and a protruding rod disposed on the recessed groove may be provided.

Further, in the present embodiment, as illustrated in FIG. 20, at a lower end of the rotary support post 220, a saw-toothed concave-convex portion 221 may be provided.

As illustrated in FIG. 20, the driven gear 230 of the rotary plate 200 is continuously provided between the rotary support post 220 and an outmost edge of the rotary body 210 and may gear-engage with the drive gear 330 of the rotary plate driver 300. As a result, when the drive gear 330 rotates, the rotary plate 200 may rotate at 360° by gear engagement between the drive gear 330 and the driven gear 230.

As illustrated in FIG. 19, the rotary plate driver 300 is disposed in the base body 110 and connected with the rotary plate 200 to rotate the rotary plate 200 at 360° and in forward and backward directions.

Meanwhile, in the present embodiment, after the supporting plate 400 is separated, the bracket on the object to be photographed is mounted may be coupled and used to the rotary body 210. At this time, the bracket may be fitted and coupled to the groove provided at the center of the rotary body 210.

In the present embodiment, as illustrated in FIG. 19, the rotary plate driver 300 includes a driver bracket 310 coupled to a bottom of the base body 110, a drive motor 320 coupled to the driver bracket 310 and electrically operating, and a drive gear 330 connected with a gear provided at the drive motor 320 to be rotated and gear-engaging with the driven gear 230.

The drive gear 330 of the rotary plate driver 300 may be rotatably supported to a bearing provided in the bracket and although not illustrated, a lower gear gear-engaging with the gear of the drive motor 320 may be provided at the lower side of the drive gear 330.

The support plate 400 is detachably coupled to an upper side of the rotary plate 200 illustrated in FIG. 19 to support the object to be photographed and may rotate at 360° like the rotary plate 200.

In the present embodiment, a coupling protrusion is provided on the support plate 400, and the coupling protrusion may be fitted and coupled to the coupling groove 211 provided on the upper surface of the rotary body 210 illustrated in FIG. 19. In addition, the support plate 400 may be detachably coupled to the rotary body 210 by a known coupling means, for example, a screw coupling and the like.

Further, in the present embodiment, a hole or a groove is provided at the center of the support plate 400 and a bracket may be fitted and coupled to the hole or the groove.

In the present embodiment, the object to be photographed, such as a full-body mannequin, upper and lower half-body mannequins, hats, watches, and accessories, maybe fixed to the bracket.

As illustrated in FIG. 19, a controller 500 is provided in the base body 110 and in the present embodiment, the controller 500 may wirelessly receive a remote signal from a remote controller or a smart phone to drive the drive motor 320.

In addition, in the present embodiment, the rotary photographing apparatus 1 may further include a photographing unit such as a DSLR or a smart phone in addition to the main body 100, the rotary plate 200, the rotary plate driver 300, the support plate 400, and the controller 500 described above. Further, in the present embodiment, the photographing unit may include a 3D scanner. That is, after the object to be photographed is scanned by the 3D scanner, the scanned object is converted into a 3D modeling to be uploaded on a website.

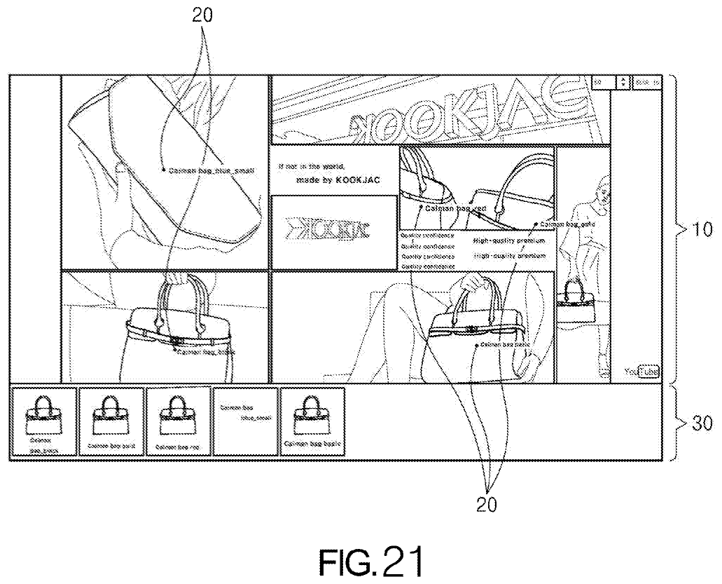

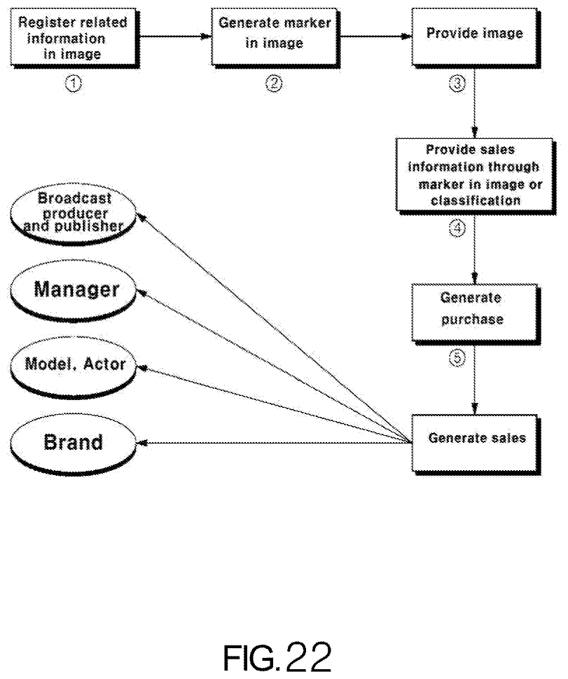

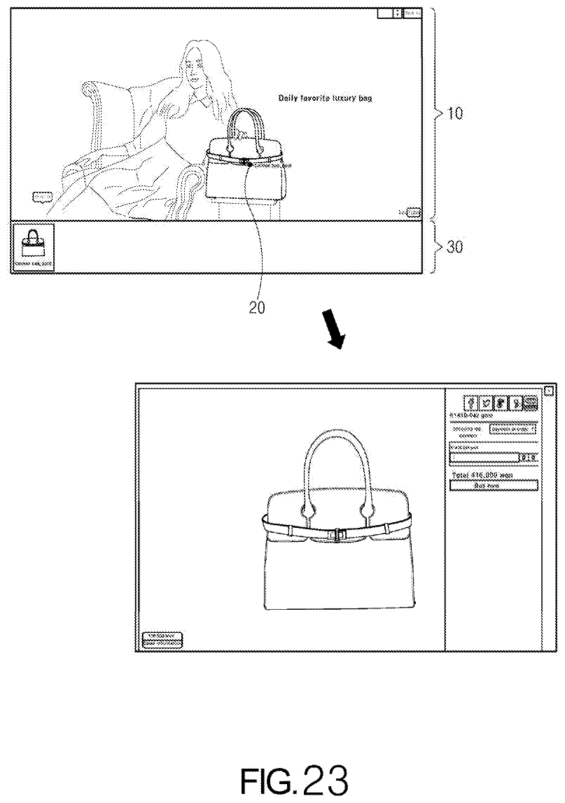

FIG. 21 is a diagram schematically illustrating a selling method in an image according to an embodiment of the present invention, FIG. 22 is a diagram illustrating main parts of the present embodiment, and FIG. 23 is a diagram illustrating a purchase screen shown to immediately purchase a sales product by a purchaser when clicking a marker illustrated in FIG. 22.

As illustrated in these drawings, a selling method in an image according to the present embodiment includes registering sales information of a sales product which is an object to be photographed by a photographing apparatus 1 in an image 10 including a moving picture through a user terminal accessing a server or a specific program, generating a marker 20 on the sales product using the user terminal accessing the server or the specific program or an image matching technique, and distributing an image generated with the marker 20 and a webpage, wherein sales information for the sales product is shown when the purchaser clicks the marker.

The registering of the sales information of the sales product includes registering an actor or a model shown in the image 10 and registering a brand of the sales product to which the actor or model shown in the image 10 is applied or used.

In the present embodiment, the when the sales product worn or used by the actor or model shown in the image 10 is registered, the object to be photographed as the sales product may be photographed by the photographing apparatus and then generated as an object modeling. In the present embodiment, the modeling of the object modeling to a 3D object may be applied with a technique disclosed in Korean Patent Registration No. 10-1562658 filed and registered by the present applicant as it is. In the present embodiment, rendering is available even in other servers which are previously predetermined in addition to the company's server.

In the present embodiment, there are various methods of making the sales product be shown three-dimensionally, and as a result, only the product image may be three-dimensionally uploaded regardless of the photographing apparatus 1. It is considered that the present embodiment may be used even in off line.

In the generating of the marker 20 on the sales product through the user terminal accessing the server, each marker 20 maybe generated every sales products which are able to be sold in the image 10.

Further, when the corresponding marker 20 in the image 10 is clicked, the sales information on the sales product may be shown. In the present embodiment, the sales information on the sales product may input a payment ratio in addition to a product name, a sales price, a sales quantity, and contents as basic information required for sales. The payment ratio and the like may be applied to a manager, an image producer, a publisher, characters, a brand company for selling a product, an image distributor, and the like.

In the present embodiment, the generation of the marker 20 may be applied with a method for setting a position of the sales product in each frame with a separate tool and two schemes of automation through image matching. In the present embodiment, the method for generating the marker 20 may be applied with a known means as it is. For example, a method for generating a marker disclosed in Korean Patent Registration No. 10-1414666 may be applied.

The image 10 applied in the present embodiment may be applied to various fields such as dramas and advertisements.

In addition, in the present embodiment, the marker 20 may be hidden or shown by an operation event such as on/off, mouse over, and pause according to a customer's operation, for example, an interface button operation.

Meanwhile, in the present embodiment, as illustrated in FIG. 22, at least one of a list of characters, a brand list, and a list for each sales product appearing at a current timing may be shown in a separate layout 30.

Among them, the list for each character may display a list of actors appearing for each time zone of the image 10 and display a list of products worn or used by the corresponding actor during clicking. Further, the brand list appearing for each time zone of the image 10 is displayed and when the corresponding list is clicked, a product list of the corresponding brand may be displayed. Furthermore, others such as classification according to the user convenience may also be displayed.

In addition, in the present embodiment, as illustrated in FIG. 23, when the sales product shown in the corresponding marker 20 or the separate layout 30 is clicked, the sales information in the image 10 is immediately displayed and then the purchaser may immediately purchase the sales product.

In the present embodiment, as illustrated in FIG. 21, sales can be paid even at a place such as a broadcast producer, a publisher, a manager, a model, an actor, a brand company, and the like according to a setting of the manager. In addition, the sales may be paid even to an image distributor.

In addition, in the present embodiment, when the mouse is over in the image 10, a sales product to be purchased may be displayed or when the image 10 is paused, the sales product may be displayed.

Meanwhile, in the present embodiment, a separate function is provided to the image distributor, who distributes the image is stored in a webpage or a program, and the image is exposed using various means such as boards or SNS, blogs, and their sites to induce the purchase, and when the purchase is made in the corresponding image, some of the sales may be paid to the image distributor.

In the present embodiment, the purchaser may immediately make a payment as described above in the corresponding advertisement page without the need to move through the link. In the present embodiment, a payment function in the corresponding VR may be generated. Further, in the present embodiment, the screen may be moved to a payment page using a QR code and a payment link may be transmitted by a short message service (SMS), a messenger, a mail, and the like.

In addition, in the present embodiment, while the Internet is not connected, when a product appearing in the image is applied for purchase, the corresponding purchase information may be stored in the program and then when the internet is connected, the purchase information may be transmitted in a batch. Further, the profits generated in the product sales may be paid to at least one of a manager (company), a publisher, a producer, a character, a brand company, an image distributor, and the like according to an agreed setting.

Meanwhile, the aforementioned steps of the present embodiment, that is, the registering of the sales information, the generating of the marker, and the registering in the website maybe performed through the user terminal accessing the server.

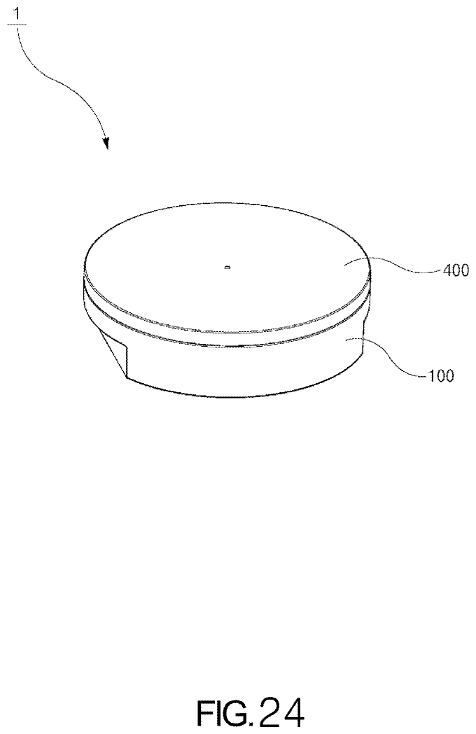

In the present embodiment, in the photographing of the object to be photographed, the photographing apparatus 1 illustrated in FIGS. 24 to 26 may be used. In the present invention, the object to be photographed may rotate at 360° using the photographing apparatus 1 and a bracket on which the object to be photographed is mounted may be variously selected.

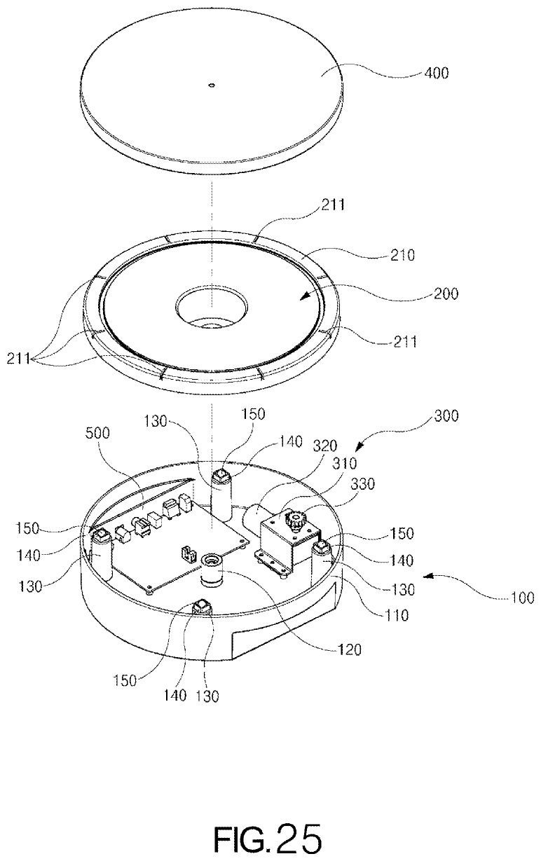

As illustrated in FIG. 25, the photographing apparatus 1 employed in the present embodiment includes a main body 100, a rotary plate 200 rotatably coupled to the main body 100, a rotary plate driver 300 provided in the main body 100 to rotate the rotary plate 200, and a support plate 400 detachably coupled to the rotary plate 200 and supporting the object to be photographed on an upper surface thereof.

As illustrated in FIG. 25, the main body 100 includes a base body 110, a central post 120 provided at a center of the base body 110, a plurality of support posts 130 provided at an edge of the base body 110, an accommodating box 140 provided in the plurality of support posts 130, and a spherical body 150 accommodated in the accommodating box 140 and coming into a cloud contact with an inner ceiling portion of a rotary body 210.

As illustrated in FIG. 25, the base body 110 of the main body 100 may have a hollow circular shape on a plan view.

The central post 120 of the main body 100 is provided at the center of the base body 110, wherein the rotary plate 200 may be rotatably coupled.

As illustrated in FIG. 25, four support posts 130 of the main body 100 may be provided to be spaced apart from each other at an inner bottom edge of the base body 110.

As illustrated in FIG. 25, the accommodating box 140 of the main body 100 is provided at an upper end of the support post 130 and serves to hold the spherical body 150 so as not to be separated to the outside.

As illustrated in FIG. 25, the spherical body 150 of the main body 100 is accommodated in the accommodating box 140 and comes into a cloud contact with the inner ceiling portion of the rotary body 210 to easily rotate the rotary body 210.

In the present embodiment, the spherical body 150 may have a circular shape.

The rotary plate 200 may be connected to the rotary plate driver 300 provided in the base body 100 to be rotatably provided in the main body 100 at 360°.

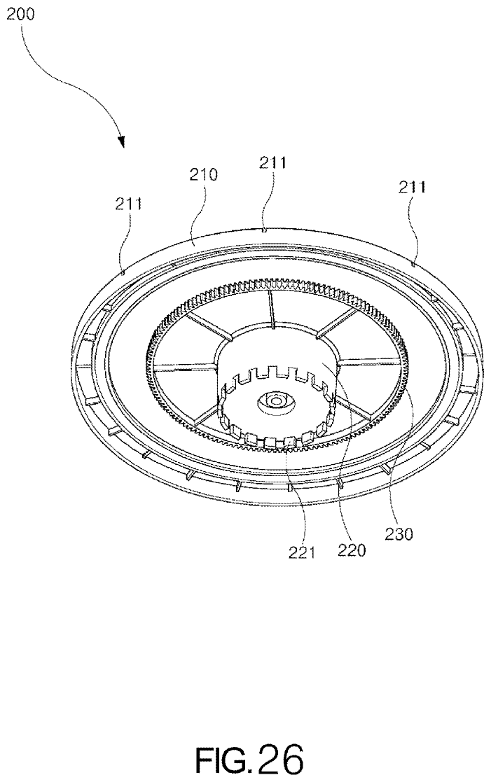

In the present embodiment, as illustrated in FIG. 26, the rotary plate 200 includes a rotary body 210, a rotary support post 220 provided at the inner ceiling portion of the rotary body 210 and connected to the central post 120, and a driven gear 230 provided at the rotary body 210 and gear-engaging with a drive gear 330 of the rotary plate driver 300.

As illustrated in FIGS. 25 and 26, in the rotary body 210 of the rotary plate 200, a plurality of coupling grooves 211 are provided to be spaced apart from each other, and coupling protrusions provided on a lower surface of the support plate 400 may be inserted and coupled to the plurality of coupling grooves 211.

As illustrated in FIG. 26, the rotary support post 220 of the rotary plate 200 is provided at the center of the rotary body 210 and connected to the central post 120 of the main body 100 to rotatably support the rotary body 210.

In the present embodiment, as illustrated in FIG. 26, at a lower side of the rotary support post 220, a recessed groove and a protruding rod disposed on the recessed groove may be provided.

Further, in the present embodiment, as illustrated in FIG. 26, at a lower end of the rotary support post 220, a saw-toothed concave-convex portion 221 may be provided.

As illustrated in FIG. 26, the driven gear 230 of the rotary plate 200 is continuously provided between the rotary support post 220 and an outmost edge of the rotary body 210 and may gear-engage with the drive gear 330 of the rotary plate driver 300. As a result, when the drive gear 330 rotates, the rotary plate 200 may rotate at 360° by gear engagement between the drive gear 330 and the driven gear 230.

As illustrated in FIG. 25, the rotary plate driver 300 is disposed in the base body 110 and connected with the rotary plate 200 to rotate the rotary plate 200 at 360° and in forward and backward directions.

Meanwhile, in the present embodiment, after the supporting plate 400 is separated, the bracket on the object to be photographed is mounted may be coupled and used to the rotary body 210. At this time, the bracket may be fitted and coupled to the groove provided at the center of the rotary body 210.

In the present embodiment, as illustrated in FIG. 25, the rotary plate driver 300 includes a driver bracket 310 coupled to a bottom of the base body 110, a drive motor 320 coupled to the driver bracket 310 and electrically operating, and a drive gear 330 connected with a gear provided at the drive motor 320 to be rotated and gear-engaging with the driven gear 230.

The drive gear 330 of the rotary plate driver 300 may be rotatably supported to a bearing provided in the bracket and although not illustrated, a lower gear gear-engaging with the gear of the drive motor 320 may be provided at the lower side of the drive gear 330.

The support plate 400 is detachably coupled to an upper side of the rotary plate 200 illustrated in FIG. 25 to support the object to be photographed and may rotate at 360° like the rotary plate 200.

In the present embodiment, a coupling protrusion is provided on the support plate 400, and the coupling protrusion may be fitted and coupled to the coupling groove 211 provided on the upper surface of the rotary body 210 illustrated in FIG. 25. In addition, the support plate 400 may be detachably coupled to the rotary body 210 by a known coupling means, for example, a screw coupling and the like.

Further, in the present embodiment, a hole or a groove is provided at the center of the support plate 400 and a bracket may be fitted and coupled to the hole or the groove.

In the present embodiment, the object to be photographed, such as a full-body mannequin, upper and lower half-body mannequins, hats, watches, and accessories, maybe fixed to the bracket.

As illustrated in FIG. 25, a controller 500 is provided in the base body 110 and in the present embodiment, the controller 500 may wirelessly receive a remote signal from a remote controller or a smart phone to drive the drive motor 320.

In addition, in the present embodiment, the photographing apparatus 1 may further include a photographing unit such as a DSLR or a smart phone in addition to the main body 100, the rotary plate 200, the rotary plate driver 300, the support plate 400, and the controller 500 described above. Further, in the present embodiment, the photographing unit may include a 3D scanner. That is, after the object to be photographed is scanned by the 3D scanner, the scanned object is converted into a 3D modeling to be uploaded on a website.

Meanwhile, in the present embodiment, there are various methods of making the sales product be shown three-dimensionally, and as a result, only the product image may be three-dimensionally uploaded regardless of the photographing apparatus 1 described above.

According to the present embodiment, it is possible to sell an object to be photographed by a photographing apparatus with marketing activities of a sales supporter and receive a support of the sales supporter.

What is claimed is:

1. A selling method comprising:
generating an object modeling of an object photographed by a photographing apparatus through a user terminal accessing a server;
registering sales information of the object modeling in a website through the user terminal accessing the server; and
applying a sales support through the user terminal accessing the server when the sales information is registered.

2. The selling method of claim 1, wherein when the object which is applied with the sales support is advertised and sold through SNS or blogs, and a home page of a sales supporter through the user terminal accessing the server, sales support money is paid to the sales supporter through a user terminal of the sales supporter accessing the server.

3. The selling method of claim 2, wherein the sales support money is an amount of money input through the user terminal of the sales supporter accessing the server.

4. The selling method of claim 1, wherein the object modeling is converted and registered into any one of virtual reality (VR), augmented reality (AR), and 3D modeling.

5. The selling method of claim 4, wherein an advertisement is inserted to the object modeling converted into the VR.

6. A photographing apparatus comprising:
a main body;
a rotary plate rotatably coupled to the main body;
a rotary plate driver provided in the main body to rotate the rotary plate; and
a support plate detachably coupled to the rotary plate and supporting the object to be photographed on an upper surface thereof.

7. The photographing apparatus of claim 6, wherein the main body includes:
a base body;
a central post provided at a center of the base body and connected to the rotary plate;
a plurality of support posts provided at an edge of the base body;
an accommodating box provided in the plurality of support posts; and
a spherical body accommodated in the accommodating box and coming into a cloud contact with the rotary plate.

8. A selling method comprising:
generating an object modeling of an object photographed by a rotary photographing apparatus through a user terminal accessing a server;
registering sales information of the object modeling in a website through the user terminal accessing the server;
advertising the object by SNS or blogs, and a home page of a sales supporter through the user terminal accessing the server; and
applying a sales support through the user terminal accessing the server when the sales information is registered,
wherein a payment of a purchaser is immediately made through the server on an advertisement page where the object to be photographed is advertised.

9. The selling method of claim 8, wherein a product to be advertised is selected by the purchaser through the user terminal.

10. The selling method of claim 9, wherein a separate website link is provided to the sales supporter through the server.

11. The selling method of claim 8, wherein when the object to be photographed which is applied with the sales support is advertised and sold through SNS or blogs, and a home page of the sales supporter through the user terminal accessing the server, sales support money is paid to the sales supporter through a user terminal of the sales supporter accessing the server, and
the sales support money is an amount of money input through the user terminal of the sales supporter accessing the server.

12. A selling method in an image comprising:
registering sales information of a sales product which is an object photographed by a photographing apparatus in an image including a moving picture through a user terminal accessing a server or a specific program;
generating a marker on the sales product using the user terminal accessing the server or the specific program or an image matching technique; and
distributing an image generated with the marker and a webpage,
wherein sales information for the sales product is shown when the purchaser clicks the marker.

13. The selling method in the image of claim 12, wherein when the marker is clicked, the sales information in the image is immediately displayed and the sales product is immediately purchased.

14. The selling method in the image of claim 12, wherein when there is a plurality of sales products in the image, the marker is provided for each sales product.

15. The selling method in the image of claim 12, wherein the marker is hidden or shown by an operation event selected from on/off, mouse over, and pause according to an interface operation.

16. The selling method in the image of claim 12, wherein at least one of a list of characters, a list of brands, and a list for each sales product appearing at a current time of the image is shown in a separate layout outside the image.

17. The selling method in the image of claim 16, wherein the separate layout is hidden or shown.

18. The selling method in the image of claim 12, wherein the sales information is three-dimensionally shown.

19. The selling method in the image of claim 12, wherein at least one of a manager, an image producer, a publisher, a character, a product brand company, and an image distributor gets a payment at a predetermined ratio when the sales product is sold.

20. The selling method in the image of claim 12, wherein when the sales product is purchased in offline, purchase information is stored in a storage device and then transmitted in a batch during an online connection.
